(19) United States
(12) Patent Application Publication
(10) Pub. No.: US 2021/0041473 A1
(43) Pub. Date: Feb. 11, 2021

(54) Robotic Liquid Handling System with On-Site, On-Demand Porous Filter Functional Media Assembly Capability for Disposable Liquid Handling Devices

(71) Applicant: Porex Corporation, Fairburn, GA (US)

(72) Inventors: Maria DeCapua Dicioccio, Marietta, GA (US); Guoqiang Mao, Peachtree City, GA (US)

(21) Appl. No.: 17/043,788

(22) PCT Filed: Mar. 28, 2019
(86) PCT No.: PCT/US2019/024474

§ 371 Date: Sep. 30, 2020

Related U.S. Application Data
(60) Provisional application No. 62/650,774, filed on Mar. 30, 2018.

(51) Int. Cl. G01N 35/10; G01N 35/00

(52) U.S. Cl. CPC G01N 35/1009; G01N 2035/1053; G01N 35/0099

(57) ABSTRACT

The present application provides robotic liquid handling and assay systems which can selectively and efficiently insert porous media into liquid handling devices, particularly into pipette tips.

### FIELD OF THE DISCLOSURE

The field of the present disclosure involves robotic liquid handling and assay systems which can selectively and efficiently insert porous media into liquid handling devices, particularly into pipette tips.

### BACKGROUND

Filtered pipette tips prevent over pipetting and aerosol based contamination of pipetting devices, liquid handling machines and aerosol based laboratory infections. Contamination of pipetting devices and liquid handling machines with infectious diseases, such as immunodeficiency virus, hepatitis A, B or C, Zika virus, meningitis, herpes, measles, Ebola, influenza or bacteria, or with radioactive reagents or caustic reagents such as acids and bases presents a health risk to laboratory personal and can damage liquid handing devices. However, filtered pipette tips cost more and have restricted air flow compared with unfiltered pipette tips. Robotic liquid handling systems consume large quantities of pipette tips. Unnecessary use of filtered pipette tips during the operation of robotic liquid handling systems significantly increases the operational cost for robotic liquid handling systems. To balance the protection of the robotic liquid handling machine and the operational cost, robotic liquid handling system users try to use both filtered pipette tips and unfiltered pipette tips during operation, however, this approach is time consuming and increases the complexity of machine programming and requires huge storage space for the pipette tips on the machine and which is not practical. There is a commercial need for a robotic liquid handling system that could provide efficient contamination protection for the pipetting devices and laboratory personal and, at the same time, reduce the cost of operating the robotic liquid handling system.

Many robotic liquid handling systems use pipette tips in racks. The racks generate waste and cost. A process of assembling pipette tips and filters into a rack on site and on demand will eliminate the waste from using multiple racks. The overall process will be more environmentally friendly and more cost effective.

### SUMMARY

The present disclosure addresses this unmet need and provides improved robotic liquid handling and assay systems which can selectively and efficiently insert porous media into liquid handling devices, particularly into pipette tips. These improved robotic liquid handling and assay systems decrease operating costs by selectively inserting porous media when desired into liquid handling devices or by not inserting porous media into liquid handling devices when the porous media is not needed, thereby decreasing use of porous media. These improved robotic liquid handling and assay systems provide protection against chemical, biological or radioactive contamination of the system and can provide liquid purification and extraction capabilities.

The present disclosure also provides a greener approach and waste reduction for liquid handling and assay by eliminating the need of providing pre-racked pipette tips that are pre-loaded with porous filters. The improved liquid handling system could use bulk pipette tips, onsite, and assemble the porous filter into the pipette selectively and on demand.

### BRIEF DESCRIPTION OF THE DRAWINGS

FIG. 1 is a schematic representation of the operation of the system to determine when a filtered pipette tip or an unfiltered pipette tip is desired in all or just specific locations.

FIG. 2 is a schematic representation of the operation of the system to determine when extraction media is desired in a pipette tip or is not desired, and a choice of either C₁₈ extraction media or silica extraction media for insertion into a pipette tip.

FIG. 3 is a schematic representation of one embodiment of the operation of the robotic system for on-site and on-demand selection of porous media for selective insertion into liquid handling devices.

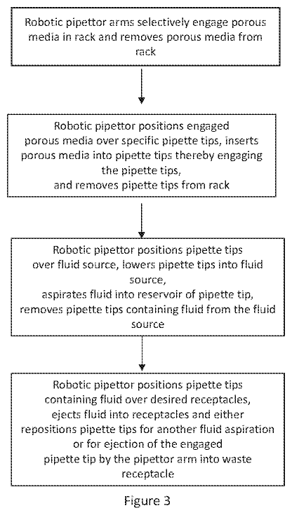

FIG. 4 is a schematic representation of one embodiment of the operation of the robotic system for on-site and on-demand insertion of pipette tip into a rack, on-site, on-demand insertion of porous filter into the pipette tips on rack, and usage of newly assembled pipette tip selectively for liquid handling.

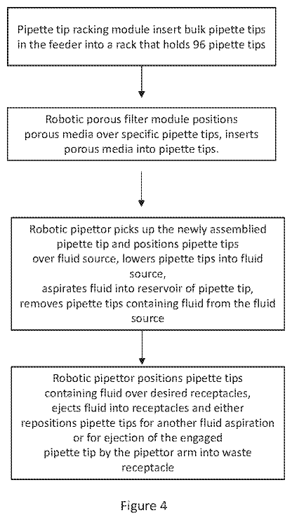

FIG. 5 is a schematic of a filter media being inserted into an open mouth end of a pipette tip.

FIG. 6 is a schematic of a filter media being inserted into a tip end of a pipette tip.

FIG. 7 is a representative image of a robotic system that may incorporate this disclosure.

### DETAILED DESCRIPTION

In one embodiment, the robotic liquid handling system can selectively insert porous media in selected pipette tips on-site and on-demand and use this assembled pipette tip when a pipette tip containing porous media is needed.

In one embodiment, the robotic liquid handling system or assay system comprises a programmable device for operating the system, a module containing porous media, a module containing liquid handling devices, mechanical or other means for inserting porous media into a liquid handling device, such as a pipette tip, and a pipetting device for attachment to the liquid handling device. In one embodiment, the programmable device contains a graphical user interface for an operator to program the device to select or not to select porous media for insertion into liquid handling devices, such as a pipette tips, for use in pipetting fluid. In some embodiments, the programmable device contains a graphical user interface for an operator to program the device to select or not to select specific types of porous media (e.g., C₁₈ silica, porous plastic filters, fiber filters, or other filter media) for insertion into liquid handling devices, such as a pipette tips, for use in pipetting fluid. It is also possible for a user to further program the device to deliver the liquid handling devices to specific locations, for example within a 96 well plate, for pipetting of fluids which may (e.g., blood) or may not (e.g., buffer) require use of porous media in liquid handling devices.

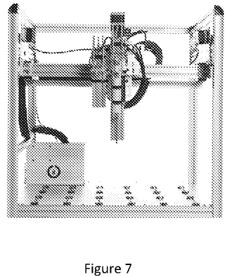

In another embodiment, the pipetting device is an automated or robotic pipetting device which can accommodate a plurality of pipetting arms or barrels which can selectively engage a plurality of porous media for placement into a plurality of pipette tips. Such robotic pipetting devices can perform a plurality of simultaneous pipetting events, are used in high throughput situations and are commercially available from companies such as Innovadyne (Rohnert Park, Calif.), Eppendorf North America (Hauppauge, N.Y.), Hamilton (Reno, Nev.), Tecan (Mannedorf, Switzerland), Roche (Indianapolis, Ind.), Beckman Coulter (Brea, Calif.). The commercially available pipetting devices have means for ejecting pipette tips to facilitate efficiency of robotic operations. An exemplary machine that may incorporate the disclosed robotic filter insertion technology disclosed herein is illustrated by FIG. 7.

The robotic system includes a pipetting device which in one embodiment is a programmable device with a plurality of pipetting arms or barrels, a module, for example a rack, containing porous media for engaging the pipetting arm on one end, removing the porous media from the module, and a module of pipette tips into which the pipetting arms lower the porous media to engage selected pipette tips. Once the porous media is inserted into the pipette tip, the pipette tips are removed from the module by the pipetting device, positioned over a desired location, for example a reservoir of fluid or a 96 well plate containing fluid, and lowered into the fluid.

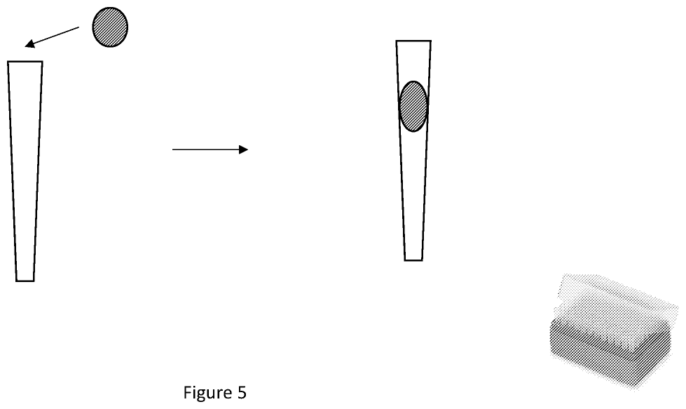

In one example, the porous media may be inserted into an open mouth of a pipette tip. This is illustrated by FIG. 5. As shown, pipette tips generally have a tapered configuration, with a larger open mouth at the top of the tapered portion. The pipetting arm may retrieve a porous media from the rack, move to the module of pipette tips (or the module of pipette tips may be moved to below the pipetting arm), then the pipetting arm inserts the porous media into the open mouth of an upright pipette tip. The porous media may be somewhat malleable such that it is caused to take the shape of the internal taper upon insertion as shown. For example, the porous media may be primarily spherical or oval prior to insertion and takes on a more tapered configuration once positioned. It is possible for the pipetting arm to provide this dual function, such that it inserts porous media as well as moves and relocates pipette tips. Alternatively, it is possible for there to be provided a separate media insertion arm for the media insertion step, with the pipetting arm maintaining only its typical pipette moving and relocating functions.

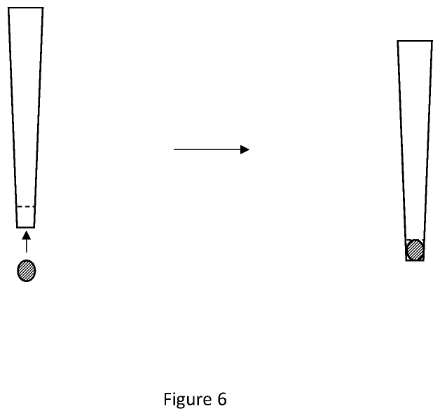

In another example, the porous media may be inserted into the tip end of a pipette tip. This is illustrated by FIG. 6. As shown, the porous media is generally spherically shaped and although it may be compressed, it is typically compressed less than the porous media of FIG. 5, because it is not inserted as far into the pipette tip body. Instead, the porous media remains at the edge of the tip end as shown. In this example, a first arm may lift the pipette tip and a second arm may position the porous media within the tip end. In an alternate example, the porous media may be positioned within the base of a pipette module, and positioning of the pipette tip over the porous media forces the porous media into the tip end.

Once the porous media has been positioned, the pipette tips are ready to draw fluid. In one example of use, the pipetting device may then apply suction to cause a selected amount of fluid to enter the liquid chamber of the pipette tip. This is followed by removal of the pipette tips from the fluid, positioning the tips containing fluid over a desired location, and ejecting the fluid into the desired location. Next, the pipette tips may be employed in a subsequent pipetting event. Alternatively, in a single use situation, the pipette tips may be ejected from the pipetting arm into a waste receptacle and a new set of porous media may be engaged by the pipetting arms, followed by selective insertion of the porous media into a new set of pipette tips for a new pipetting event.

Receptacles to receive fluid from pipette tips include, but are not limited to, tubes (glass or plastic), cell culture plates and microplates. Microplates may have numerous wells, for example 6, 12, 24, 48, 96, 384, 1536, 3456 or 9600 sample wells arranged in a rectangular matrix.

In one embodiment, a pipetting device containing 96 pipettors and capable of performing 96 simultaneous pipetting events is employed. The pipetting device is programmed to selectively engage 96 porous media in a module, such that each one of the 96 pipettors or selected specific pipettors engages a porous medium in a module. Next, the 96 pipettors with or without porous media are lifted up away from the module, and positioned over 96 pipette tips in another module. The 96 pipettors with or without attached porous media are then inserted into the pipette tips such that the porous media is inserted into a first opening of selected pipette tips and engages the pipette tips. Next, the pipettors with or without attached porous media and pipette tips are lifted away from the pipette tip module and the second end of each pipette tip is inserted into a reservoir containing a fluid. A desired volume, for example 50 μl is drawn into each of the 96 pipette tips by the pipetting device. The pipette tips are then removed from the blood and positioned over a 96 well plate containing reagents, such that each pipette tip is located over one well. The 50 μl of fluid is then expelled by the pipettor from each pipette tip into the 96 wells. This process is optionally repeated for a selected number of 96 well plates. When pipetting is completed, the pipette tips are ejected from the barrels of the pipettors and discarded. It is to be understood that the module that contained the pipette tips are removed and may be subsequently stacked and stored for subsequent loading with new pipette tips. The pipette tips containing the porous media prevent contamination with the pipette barrels of the pipettors in the pipetting device.

There are many combinations of using the pipette tips containing or not containing porous media depending on the assay protocol. Engaging the modules of porous media and pipette tips together on the site of application provides significant savings in the space required to store such modules. It also significantly reduces the cost by eliminating the unnecessary usage of pipette tips containing porous media by programming the robotic pipetting machine to directly engage with the pipette tips without porous media when the step requires pure water or buffers instead of aerosols, blood, caustic reagents, such as acids, or radioactive reagents that might contaminate the pipetting machine.

In another embodiment, the robotic liquid handling system or a robotic assay system can selectively insert functional porous media as a filter on-site and on-demand into the disposable sample purification devices and use these assembled devices with functional porous media to collect, purify and analyze targeted samples. In one embodiment, the functional porous media is in a three dimensional form that can selectively bind an analyte from the solution. The functional porous media in this embodiment may contain functional groups or additives. Functional groups include, but are not limited to biotin, streptavidin, protein A, antibodies and probes. In some embodiments, functional additives are in a particle form, such as C₁₈ silica, controlled porous glass, etc., that can selectively bind targeted molecules.

In yet another embodiment, the present disclosure provides a robotic liquid handling or assay system with an on-site and on-demand porous media assembly capability.

In another embodiment, the present disclosure provides a robotic liquid handling or assay system with an on-site and on-demand porous media assembly capability to insert the porous media into the disposable liquid handling device.

In yet another embodiment, the present disclosure provides a robotic liquid handling or assay system with an on-site and on-demand porous media assembly capability to the disposable liquid handling devices for collecting, transferring, purifying or dispensing liquid. In still another embodiment, the present disclosure provides a robotic liquid handling or assay system with a porous media assembly module that is capable of inserting porous media into a disposable liquid handling device used for collecting, transferring, purifying or dispensing liquid. The module containing porous media may be detachable from the system or may be affixed to the system and loaded with porous media before use.

In another embodiment, the present disclosure provides a robotic liquid handling or assay system with a porous media assembly module that is capable of inserting porous media into a disposable liquid handling device used for collecting, transferring, purifying or dispensing liquid wherein the module can dispense and assemble different porous media on demand. In one embodiment, a module containing porous media may have different types of porous media which may be selected on demand by the system for insertion of the desired porous media into a liquid handling device. In another embodiment, a module containing porous media may have the same type of porous media which may be selected on demand by the system for insertion of the desired porous media into a liquid handling device. In another embodiment, several modules each containing a different porous media may be selected on demand by the system for insertion of the desired porous media into a liquid handling device.

In one embodiment, the porous media in the present disclosure is a porous filter. Porous filters in the present disclosure include, but are not limited to, sintered porous plastic filters, sintered elastomeric filters, porous fiber filters, porous glass filters, and screens. Porous filters in the present disclosure may also comprise other additives, such as polytetrafluoroethylene (PTFE), super absorbents and/or color changing media. Porous filters in the present disclosure are sufficiently rigid to withstand mechanical or other forces such as air pressure to be inserted into the liquid handling device. These types of porous filters are described in U.S. Pat. Nos. 8,187,534, 8,141,717, EP Patent No. 1402016, and U.S. Pat. No. 5,364,595.

The disposable liquid handling devices in this application include pipette tips, and other liquid suction or dispensing devices.

The functional porous media in the present disclosure include, but are not limited to, sintered porous media with various reagents, including but not limited to, protein A, antigen specific polycolonal or monoclonal antibodies, avidin, streptavidin, biotin, C₁₈ silica, C₁₂ silica, C₈ silica, C₄ silica, oligonucleotides, polynucleotides, peptides, with ion exchange resins, with activated carbon, carbon nano-tube, graphene, controlled porous glass (CPG) and other purification media in particle format.

The on-site and on-demand assembled filtered pipette tip in the present disclosure can block aerosol bypass under regular pipetting operations. In different embodiments, the on-site and on-demand assembled filtered pipette tip in the present disclosure can block aerosol bypass under regular pipetting operation with a bacterial filtration efficiency over 95%, over 98%, over 99%, over 99.9%, or over 99.999% based on the ASTM 2101 test.

In different embodiments, the on-site and on-demand assembled filtered pipette tip in the present disclosure has the capability to block liquid flow through the filter at a pressure over 1 pounds per square inch (psi), over 2 psi or over 5 psi.

The porous media dispensing or assembly module in the present disclosure may contain multiple cartridges and each cartridge may contain different porous media. For example, a porous media dispensing module may contain three cartridges, one cartridge contains 100 μl filters, a second cartridge contains 200 μl filters and a third cartridge contains 1000 μl filters. In another example, a porous media dispensing module may contain three cartridges, one cartridge contains C₈ filters, a second cartridge contains C₁₈ filters and a third cartridge contains filters without additives.

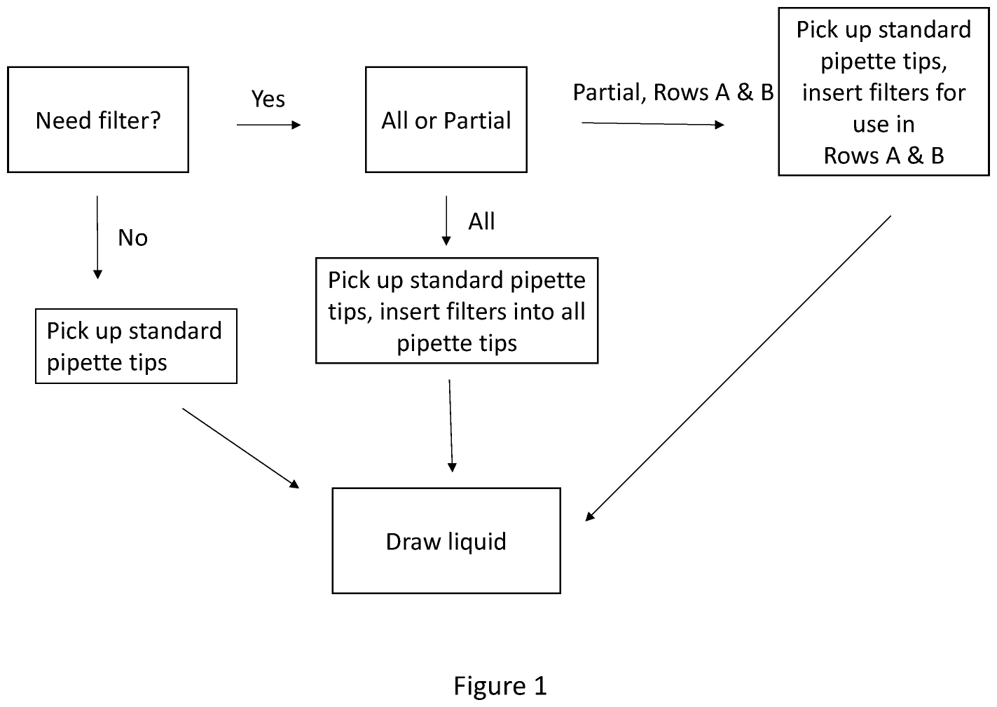

FIG. 1 shows a typical program for a 96 well plate robotic liquid handling system. The system contains unfiltered pipette tips and a filter assembly module. The program contains a user interface (selection screen) for each liquid uptake step and the operator can program the system to assemble or not to assemble the filters into the pipette tips based on the need. For example, when a step is a buffer rinsing step, the operator could select “no” on the filter selection screen; when a step is loading blood samples, the operator could select “yes” on the filter selection screen. When the robotic liquid handling system runs an entire assay, the system will pick up non-filtered pipette tips for all steps that are programmed with “no” on the filter selection screen; the system will assemble the porous filters into the non-filtered pipette tips to form filtered pipette tips and use these on-demand formed filtered pipette tips for the steps indicated with “yes” on the filtered selection screen. Since a robotic liquid handling system generally performs multiple tasks in one step, such as a typical 96-well format assay system, the program can also selectively assemble filters into pipette tips in specified locations. For example, in a 96-well format, in a single liquid uptake step, only rows A and B may need filtered pipette tips, and other rows (rows C to H) do not need filtered pipette tips. The operator can program the system to assemble the porous filters into unfiltered pipette tips and use the on-demand formed filtered pipette tips when the system performs liquid transfer in the wells in rows A and B. The operator can program the system not to assemble filters into the pipette tips and use non-filtered pipette tips for the wells in the rows C to H.

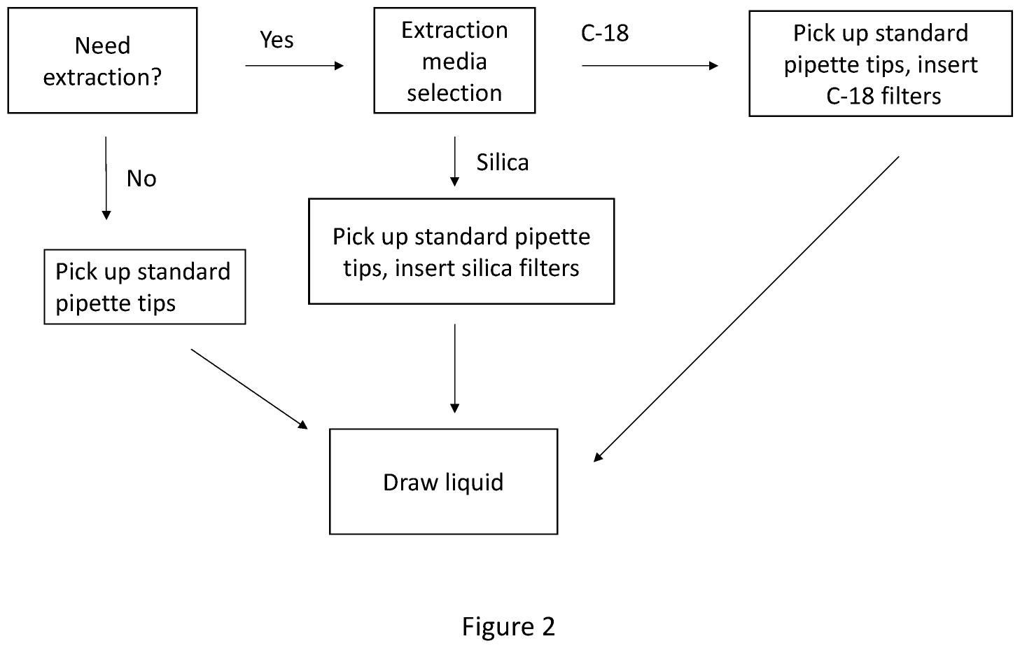

FIG. 2 shows a typical process for a robotic liquid handling system for selectively using different functional porous media in a liquid assay. The system contains standard non-filtered pipette tips and a module containing different functional porous media. The program contains a user interface (selection screen) for each liquid uptake step and the operator can program the system to assemble or not to assemble the functional porous extraction media into the pipette tips based on the need. For example, when a step is a buffer rinsing step, the operator can select “no” on the extraction selection screen; when a step is a sample extraction step, the operator can select “yes” on the extraction selection screen. The program can further contain steps for selection of specific extraction media, such as C₁₈ media or silica media. When the robotic liquid handling system runs an entire assay, the system will pick up standard non-filtered pipette tips only for all steps that are indicated with “no” on the selection screen; the system will assemble the selected functional porous extraction media into the standard non-filtered pipette tips to form functional pipette tips and will use these on-demand formed functional pipette tips for the steps indicated with “yes” on the extraction selection screen.

This system will significantly reduce the need to store different pipette tips in the working area, which is very limited in space and will decrease the operational cost.

In different embodiments, the porous media dispensing or assembly module in the present disclosure can rotate, spin or vibrate.

In one embodiment, the porous media dispensing or assembly module in the present disclosure may have an air inlet and compressed air can be used to move the porous media into a liquid handling device. In another embodiment, the porous media dispensing or assembly module in the present disclosure may spin and centrifugal force may dispense the porous media into a liquid handling device. In yet another embodiment, the porous media dispensing or assembly module in the present disclosure may vibrate and dispense the porous media through an opening in the module into a liquid handling device.

In another embodiment, the porous media dispensing or assembly module in present disclosure may have a channel to lead the porous media from the module to the disposable liquid handling device.

In one example, the module in the present disclosure resembles a powerball drawing machine. The spherical porous media to be assembled into the disposable device, such as a pipette tip, are in a container with an air inlet and an air outlet, wherein compressed air is introduced through the air inlet to agitate the porous media in the container. The porous media drops through an air outlet into the disposable device. The container can also be rotated at selected speeds to make sure the porous media move out through the outlet. There are many possible ways to deliver porous media into the disposable device and the methods of assembly are considered as commonly known to one of ordinary skill in the art.

In another embodiment, the porous media dispensing or assembly module in the present disclosure inserts the porous media into a disposable liquid handling device by mechanically pushing the porous media. Mechanical pushing includes, but is not limited to, using a rod or compressed air. The porous media may be inserted into different locations in disposable liquid handling device. For example, the porous media may be inserted into the middle of a pipette tip or near the larger opening of the pipette tip to function as an aerosol barrier. In another example, the porous media may be inserted into the tip of a pipette tip to function as a liquid filter and purification media. Examples are illustrated by FIGS. 5 and 6.

In one embodiment, the porous media in present disclosure has a symmetrical structure and can be inserted into a disposable liquid handling device without pre orientation.

In various embodiments, the porous media in the present disclosure may have a spherical, cylindrical, or ellipsoid shape.

In one embodiment, the porous media in present disclosure are self-supporting or relatively rigid but flexible enough to be capable of some compression when inserted into a disposable liquid handling device such as a pipette tip.

In one embodiment, the porous media assembled into disposable liquid handling device has direct contact with the inner wall of the device.

In various embodiments, the porous media assembled into the disposable liquid handling device has direct contact with the inner wall of the device, wherein the contact length between the porous media and device wall is more than 0.5 mm, more than 1 mm or more than 2 mm. These lengths provides a good seal between the porous media and disposable device for preventing liquid or aerosol bypass.

In one embodiment, the present disclosure provides a method of assembling a porous media into a disposable liquid handling device on-site and on-demand for a robotic liquid handling or assay system before the step of liquid handling.

In another embodiment, the present disclosure provides a method of assembling a porous filter into a disposable pipette tip on-site and on-demand for a robotic liquid handling system before the step of liquid handling.

In one embodiment, the present disclosure provides a method of selectively assembling a porous filter into selected pipette tip on-site and on-demand for a robotic liquid handling system when a filtered pipette tip is needed before the step of liquid handling.

In another embodiment, the present disclosure provides a robotic process for collecting, transferring, purifying or dispensing a liquid comprising selectively assembling a porous media into a disposable liquid handling device on-site and on-demand to form a functional disposable liquid handling device, using the newly formed functional disposable liquid handling device to collect the liquid sample, transfer the liquid sample, purify the liquid sample or dispense the liquid sample into a target.

In one embodiment, the present disclosure provides a robotic process for collecting, transferring, purifying or dispensing a liquid comprising selectively assembling a porous filter into a pipette tip on-site and on-demand to form a filtered pipette tip, using the newly formed filtered pipette tip to collect the liquid sample, transfer the liquid sample, purify liquid sample or dispense the liquid sample into a target.

In another embodiment, the present disclosure provides a robotic liquid handling or assay process have a series of steps of collecting, transferring, purifying or dispensing a liquid; some of the steps comprise porous media assembly steps when it is desirable to prevent contamination, such as with biological fluid transfer, and some steps do not comprise porous media assembly steps, for example when a buffer may be pipetted and prevention of contamination is not an issue. For example, a diagnostic assay may employ a 96 well plate with a robotic liquid handling system having 12 liquid uptake channels. The assay comprises six liquid uptake steps. Five liquid uptake steps are for buffers and these do not require filtered pipette tips. One uptake step is for blood samples and filtered pipette tips are required to prevent contamination. In this case, the sintered porous plastic filters are assembled into the pipette tips before the liquid uptake channels pick up the pipette tips for removing the blood samples using a programmed procedure. The on-site on-demand filter assembly in the present disclosure decreases operational cost by only using 96 filtered pipette tips instead of 576 filtered pipette tips.

In another embodiment, the present disclosure provides a robotic liquid handling or assay process that incorporates a series of steps, including arranging a liquid handling device into a rack, collecting, transferring, purifying or dispensing a liquid. One of the steps may comprise arranging the liquid handling device from a bulk package of pipette tips into racks. For example, most liquid handling devices, such as pipette tips are sold in pre-racked form. Each rack contains 96 pipette tips. A diagnostic assay may employ thousands of pipette tips and may needs hundreds racks of pipette tips. All hundreds racks will need to be disposed as the waste. The assembly and arrangement capability of pipette tips from the bulk packaging to the rack on-site and on demand in the present disclosure eliminates the need of using pre-racked pipette tips, makes the process greener, and provides a cost reduction. For example, for a system that requires 9600 pipette tips for liquid handling, this system will reduce need of 100 racks.

In various embodiments, the porous filters in the present disclosure may also comprise other additives, such as super absorbents and/or color changing media.

### Example 1. Assemble a Spherical Sintered Porous Filter into a Pipette Tip Selectively

A liquid handling system moves a rack of 10-200 μl unfiltered pipette under a module containing 1000 spherical sintered porous plastic filters (also referred to as filter media or porous media herein). The sintered porous plastic filter may have a 4.0 mm diameter and an average 25 microns pore size. The module drops spherical filters into the open mouth of pipette tips in the first row of 96 rack and the filters are further pushed with a rod into the location and form a barrier. The filters have flexibility and form about 1 mm direct contact with the pipette tip wall. This is illustrated by FIG. 5.

The pipette tips in the rack are picked up by the liquid handling system for drawing the liquid and dispensing the liquid into target containers.

### Example 2. Assemble a Sintered Porous Filter onto the Tip of Pipette Tip Selectively

A liquid handling system picks up a 10-200 μl unfiltered pipette tip with an end tip structure shown in FIG. 6. The end tip of the pipette tips have an opening of about 1.5 mm. The sintered porous plastic filter (also referred to as filter media or porous media herein) may also have a 1.5 mm diameter and an average 25 microns pore size with C-18 silica. The filter is pushed into the tip end opening and secured in the location via friction fit therein. The filters have flexibility and form about 0.5 mm direct contact with the pipette tip wall. This insertion may be accomplished via a first arm that lifts the pipette tip from the rack and a second arm that positions the filter within the tip end.

The pipette tips are put on a rack and then used to pick up the liquid using the liquid handling system. The location and number of assembly is decided by the program.

All patents, publications and abstracts cited above are incorporated herein by reference in their entirety. It should be understood that the foregoing relates only to preferred embodiments of the present disclosure and that numerous modifications or alterations may be made therein without departing from the spirit and the scope of the present disclosure as defined in the following claims.

1. A robotic liquid handling system or assay system comprising:
a programmable device for operating the system;
a module containing porous media;
a module containing at least one liquid handling device;
mechanical or other means for inserting porous media into the at least one liquid handling device.

2. The robotic liquid handling system or assay system of claim 1, wherein the porous media is a filtration media or an extraction media.

3. The robotic liquid handling system or assay system of claim 1, wherein the at least one liquid handling device is a pipette tip.

4. The robotic liquid handling system or assay system of claim 3, wherein the porous media is inserted into an open mouth of the pipette tip.

5. The robotic liquid handling system or assay system of claim 3, wherein the porous media is inserted into a tip end of the pipette tip.

6. The robotic liquid handling system or assay system of claim 1, wherein at least one of the modules is detachable from the liquid handling system or assay system.

7. The robotic liquid handling system or assay system of claim 1, wherein the porous media is a selected from the group consisting of a sintered porous plastic filter, sintered elastomeric filter, porous fiber filter, porous glass filter, and a screen.

8. The robotic liquid handling system or assay system of claim 1, wherein the programmable device can be programmed to select one or more types of desired porous media from one or more modules containing porous media for insertion into one or more liquid handling devices.

9. The robotic liquid handling system or assay system of claim 1, wherein the mechanical or other means for inserting porous media into a liquid handling device comprises a pipetting arm.

10. The robotic liquid handling system or assay system of claim 1, wherein the mechanical or other means for inserting porous media into a liquid handling device comprises a first arm for raising the liquid handling device from the module containing the liquid handling device and a second arm for retrieving porous media from the module containing porous media and positioning the porous media within the liquid handling device.

11. A robotic liquid handling system or assay system comprising:
a programmable device for operating the system;
a module containing porous media;
a module containing a plurality of liquid handling devices;
mechanical or other means for inserting porous media into the at least one liquid handling device; and
an arm for arranging the plurality of liquid handling devices into a rack.

12. The system of claim 11, wherein the liquid handling device comprises a pipette tip.

13. The system of claim 11, where in the arm for arranging the plurality of liquid handling devices comprises a first arm for raising one liquid handling device from the module containing the plurality of liquid handling device and a second arm for retrieving porous media from the module containing porous media and positioning the porous media within the liquid handling device.
